(19) United States
(12) Patent Application Publication
(10) Pub. No.: US 2024/0206391 A1
(43) Pub. Date: Jun. 27, 2024

(54) SIDE MOUNT TIME OF FLIGHT GRAIN FILL SENSOR

(71) Applicant: CNH Industrial America LLC, Racine, WI (US)

(72) Inventor: Scott Glovier, Lombard, IL (US)

(21) Appl. No.: 18/086,207

(22) Filed: Dec. 21, 2022

(51) Int. Cl. A01D 41/127; A01D 90/10; G01F 23/284; G01F 23/2962; G05D 1/02

(52) U.S. Cl. CPC A01D 41/1275; A01D 90/10; G01F 23/284; G01F 23/2962; G05D 1/021; G05D 2201/0201

(57) ABSTRACT

Systems and methods are disclosed for sensing and analyzing filling of a grain cart while receiving grain from a combine. Time-of-flight sensors may be mounted on the cart and used to provide signals indicative of distances of surfaces of accumulating grain from the sensors, and these distances may be determined by onboard processing circuitry. Other parameters such as cross-sectional areas, volumes, and locations in the cart may be determined based on the sensed signals. Open or closed loop control of cart and/or combine positioning may be provided based on the signals.

### BACKGROUND

The present disclosure relates generally to a side mount time of flight grain fill sensor.

Many grains are harvested by combine harvesters (combines), which cut, partially process, and separate grain for collection. Modern combines are driven in a field being harvested by an operator, and collection vehicles, such as grain carts, approach the combines to collect the grain as the harvest progresses. The combines also include their own grain tanks that serve to temporarily store grain when needed, such as during the times when a full cart leaves and a next cart is positioned to receive the grain. But this is short-term storage only, and the process should be smooth and continuous to efficiently proceed with harvest.

Thus, combines routinely unload their grain tank into a grain cart pulled by a tractor such that the combine can continue harvesting without overfilling its grain tank. The unloading process is currently a manual operation where the combine operator typically unloads gain in a specific area of the grain cart until that area is full, then the combine and grain cart are repositioned such that an empty area of the grain cart can then be filled.

There is a need to improve on this system, and to at least partially automate it, or to augment and help the machine operators in properly and efficiently filling the carts, and positioning the machines, and coordinate for successive carts during harvest.

### SUMMARY

In certain embodiments, a system comprises a sensor positioned to sense an upper surface of grain being transferred into a grain cart by a combine. Processing circuitry receives and analyzes a signal based upon output of the sensor, and determines height data representative of height of the grain in the grain cart. An operator interface coupled to the processing system and outputs an operator perceptible notice based on the height of the grain in the grain cart. The system may also allow for automated or semi-automated control of relative positions between the combine and grain cart based on the determined height, or an area or volume of grain in the cart.

### BRIEF DESCRIPTION OF THE DRAWINGS

FIG. 1A is a diagrammatical representation of an exemplary combine and grain cart according to the present disclosure;

FIG. 1B is a diagrammatical elevation of the combine and cart of FIG. 1;

FIGS. 2A-2C are diagrammatical views of grain being delivered to a grain cart, with a sensing system in accordance with the disclosure;

FIG. 3 is a diagrammatical view of a spout extending from a combine and illustrating certain possible positioning options for the spout and its associated nozzle;

FIG. 4 illustrates a technique for sensing grain collecting in the cart;

FIG. 5 illustrates an exemplary type of area or volumetric analysis that may be made based on sensing of levels of grain in the cart;

FIG. 6 is a block diagram of exemplary functional components of a system for sensing grain transferred from a combine to a grain cart; and

FIG. 7 is a diagram of an exemplary process for sensing and analyzing data relating to filling of a grain cart.

These and other features, aspects, and advantages of the present disclosure will become better understood when the following detailed description is read with reference to the accompanying drawings in which like characters represent like parts throughout the drawings, wherein:

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

As described below in reference to the drawings, the disclosure provides an electronic system to measure the current fill level of the grain in a given section of the grain cart. The system is particularly valuable for spill prevention, feedback to an automated filling system, and calculating the percent fill of the grain cart of operational logistics applications.

In some embodiments, two time of flight sensors (such as ultrasonic and/or radar sensors) may be mounted across from each other on the sides of the grain cart and angled downward to receive a reflection from the slope of the grain mound close to each side of the grain cart. These two signals as well as the geometry of the grain cart and assumptions about the angle of repose of the grain can then be used to calculate the cross-sectional area of the grain in that slice of the grain cart. Further assumptions about the angle of repose of the grain about the length of the grain cart can then be used to calculate the volume of grain in a given section of the grain cart. Depending on the length of the grain cart, further pairs of sensors would be used to measure grain in different sections of the cart along the length. The number of pairs used could be decided upon by the length of the grain cart and knowledge of the angle of repose of the grain that cart is to be used with, or by defining “fill zones” within the cart where the combine is only able to unload with the combine spout directly in line with a pair of sensors.

A design with sensors mounted on the sides of the art may be advantageous because the sensors can always measure the grain as the cart is being filled without need to worry about the combine unload tube unloading directly on top of the sensor if the sensor was mounted more towards the side-to-side center of the cart. Additionally, multiple sensors on the sides of the cart provide good feedback as to the height of the grain at both sides of the cart which can be particularly useful for spill prevention.

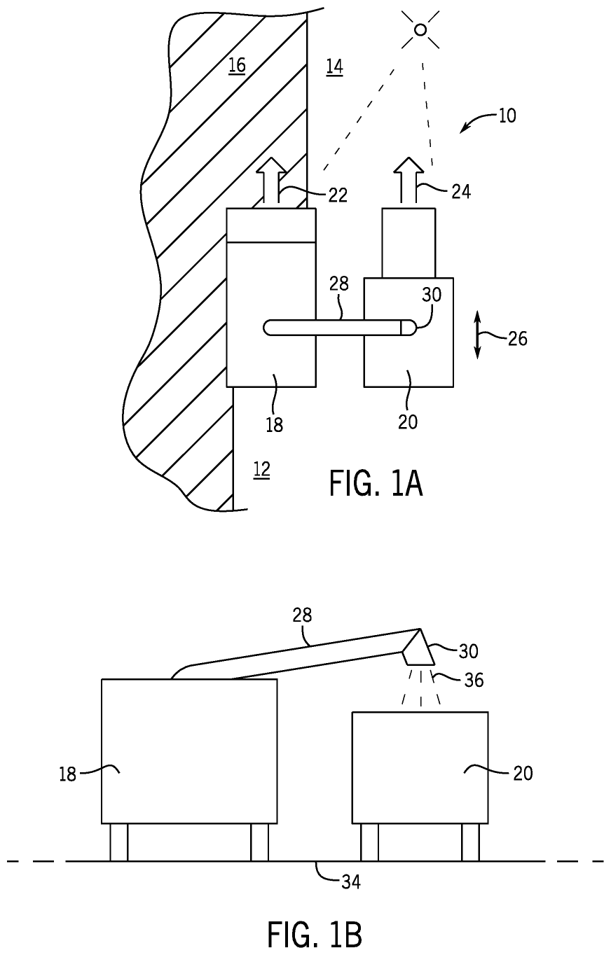

Referring to the drawings, FIG. 1A is a diagrammatical representation of an exemplary embodiment of a harvesting system 10 for harvesting grain, such as corn, wheat, or any other desired grain from a field 12. As harvesting progresses, the field will include areas 14 that have been harvested, and areas 16 of standing crops. A combine harvester (combine) 18 includes systems for cutting and partially processing the grain (e.g., to separate the grain from stalks, etc.) as will be appreciated by those skilled in the art. The grain is then transferred to a grain cart 20, which may be a vehicle with a containment volume designed to receive and transport the grain, or a towed vehicle pulled by a tractor or other traction machine. The combine proceeds as indicated by arrow 22, while the grain cart advances in parallel as indicated by arrow 24. Relative positions of the combine and the grain cart may be adjusted from to time, as indicated by arrow 24, so that the grain is deposited where desired in the cart, such as to maximize grain transported per cart, while avoiding or minimizing spillage.

As grain is processed, it may be collected in a grain tank (not shown) internal to the combine, and is ultimately moved into a spout 28 that extends from the combine at least partially over the grain cart. A nozzle 30 may aid in properly reorienting the flow of grain into target areas of the cart. Also shown in FIG. 1A is a graphical representation of a positioning system 32, such as the global positioning system (GPS). The combine or the grain cart, or both may include GPS receivers that aid in locating them in the field, and with respect to one another. Based on such positioning and location systems, the relative positions of the combine and cart may be adjusted, and locations of grain being deposited in the cart may be adjusted (by this relative adjustment of the combine and cart, or by adjustment of some other element, such as the spout and/or the nozzle), as discussed below.

It should be noted that while in the present disclosure reference is made to processes on or in the “grain cart,” much or all of the signal processing, GPS location, feedback, and control may be performed by onboard systems of a traction vehicle, such as a tractor, that tows the grain cart, particularly when the grain cart comprises a vehicle such a trailer without its own means of propulsion.

FIG. 1B is a diagrammatical elevational representation of relative positioning of the combine and cart. Both are shown driving along a ground level, which in practice could be flat, inclined, and so forth, depending upon field conditions. As shown, the spout extends over the cart, and the flow of grain, indicated by reference numeral 36 is directed by the nozzle 30 into the inner volume of the cart.

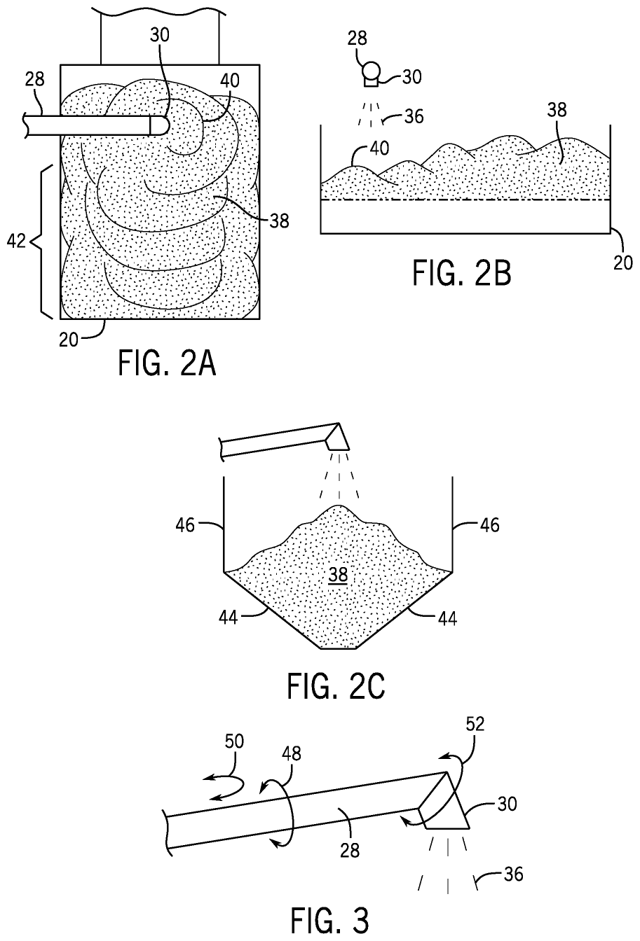

FIGS. 2A-2C are diagrammatical views of grain being delivered to the grain cart, with a sensing system to determine amounts or levels of grain at one or more locations in the cart. As mentioned above, the deposited or transferred grain 38 is delivered by the spout 28 and nozzle 30. The grain will stack and mount in locations over which the nozzle is positioned, as indicated by reference numeral 40. In general, and based on the length of the width and length of the cart, it will be desirable to fill sections of the cart, as indicated by reference numeral 42, and to reposition the combine and/or the cart to progressively fill different sections until the entire cart is satisfactorily filled. A goal of the operation is to maximize the use of the cart volume, while avoiding spillage. In the illustrated embodiment, a sloped bottom 44 is shown for this cart design, which fills first and facilitates later emptying of the cart. Lateral sides 46 extend from the bottom to form an open volume for receiving the grain.

For efficient harvesting, a goal is to continuously operate the combine, while grain carts are rotated in a batch-type manner, with each grain cart being appropriately filled and loaded while avoiding spillage. Once full, grain is retained in the inner grain tank of the combine, until the full grain cart can be moved, and an empty grain cart positioned to take its place. The inner grain tank is then emptied into the new cart and the transfer continued with the new cart being similarly fully loaded.

In some embodiments it may be possible to influence the location of delivery of grain to the cart by changing the positions of the spout 28 or nozzle 30, or both, as illustrated in FIG. 3. Here, the spout is shown to be capable of rotation as indicated by reference numeral 48, and fore-and-aft movement, as indicated by reference numeral 50. Similarly, the nozzle 30 could be movable as indicated by reference numeral 52. Where provided, such movement may be controlled by appropriate actuators (not shown) that could be controlled by an operator, or by an automated system of the type discussed below. Moreover, such movement could be based on sensing of grain levels as set forth in the present disclosure.

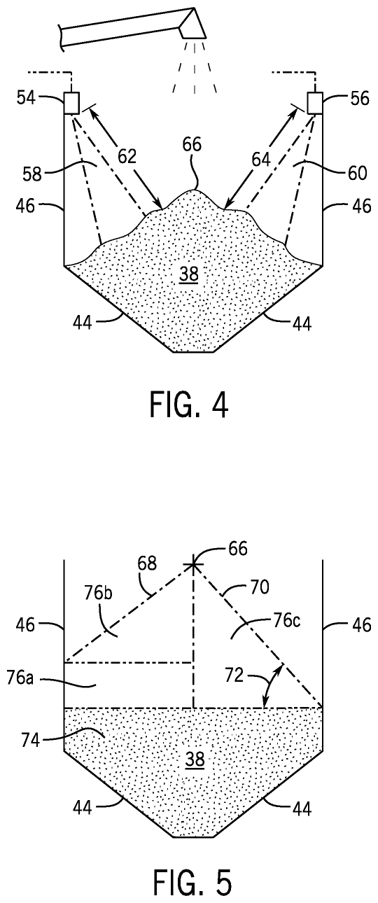

FIG. 4 illustrates an exemplary technique for sensing grain collecting in the cart. In the illustrated embodiment, two sensors 54 and 56 are positioned on upper locations on the sides 46 of the grain cart. Any suitable type of sensor may be used, and in presently contemplated embodiments, time-of-flight sensors such as ultrasound and/or radar sensors are used. In operation, these sensors emit signals that cause a reflected signal to return from an area of the surface of the grain being deposited, as indicated by reference numerals 58 and 60 for sensors 54 and 56, respectively. The surface areas of the grain returning the signals will have distances 62 and 64, respectively, from known positions of the sensors, which can be determined by the sensing of the returned signals. Each sensor will be coupled to processing circuitry, described below, as indicated by the dashed lines in FIG. 4.

In some embodiments, and particularly depending upon the length of the cart, more than one pair of sensors may be used. That is, pairs of sensors may be positioned along the length of the cart. Such multiple sensors may allow for more detailed determination of grain filling in different sections of the cart, or even for mapping of the fill. In some embodiments, sensors may be staggered in locations (i.e., not directly opposite one another on either side of the cart). In still other embodiments, it may be useful to employ a single sensor to obtain a determination of grain level or fill.

In general, it will be advantageous to determine levels of grain, though other level-related measurements may be determined and used. As shown in FIG. 5, for example, the grain may be envisaged and analyzed in slices or segments (e.g., “through” the progressively stacking grain). The mound of grain, as shown in the figure, will generally have a more or less well-defined peak 66, with sloping sides 68 and 70, which may or may not be the same height. As will be appreciated by those skilled in the art, stacking of granulated materials, if not spread by some mechanical means, may assume a known angle of repose 72, which may depend on the size and type of material, in this case, the grain being harvested. The areas of the collected grain may then be analyzed by reference to the cart geometry (e.g., width, bottom geometry, etc.), to determine different cross-sectional areas, such as a lower area 74, and partial upper areas 74 and 76. All of these may be calculated based on the detected distances as determined from the sensors (see FIG. 4). In this way, the overall area of grain in the slice or segment of the cart may be determined by piece-wise integration (e.g., addition). Moreover, with knowledge of location in the cart, lengthwise, volumes of grain and of grain at locations along the cart may be determined.

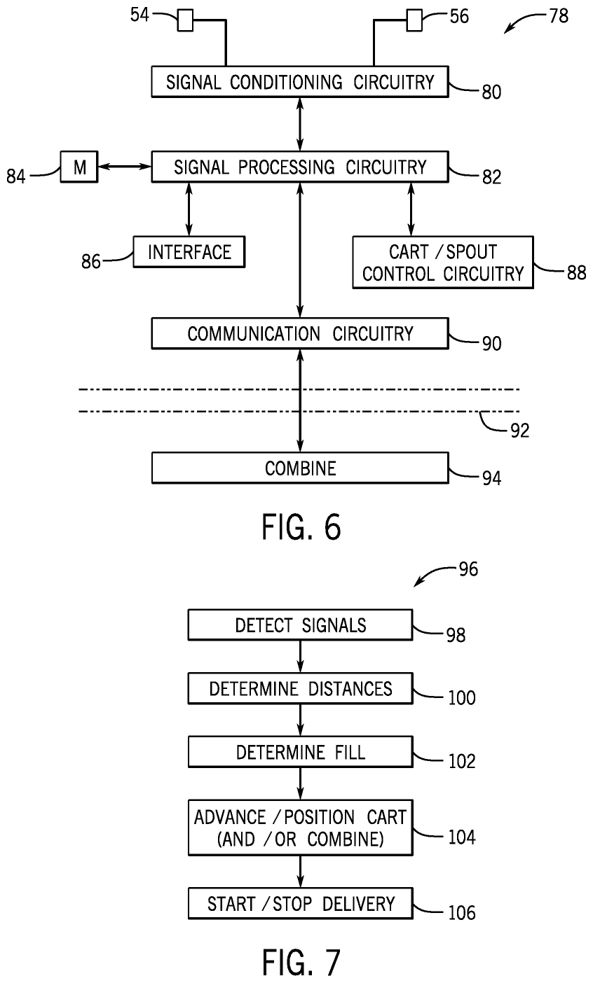

FIG. 6 is a block diagram of exemplary functional components of a system for sensing grain transferred from a combine to a grain cart. The system 78 will include the sensors 54 and 56, again shown as a pair, though other numbers of sensors may be used. These sensors generate signals indicative of distances between each sensor and a surface area of the grain accumulating in the cart, as discussed above. These signals then are applied to signal conditioning circuitry 80 that may perform signal conversion, scaling, and any other desired operations. The partially processed signals are then applied to signal processing circuitry 82, which may comprise, for example, digital processors, on-board computers, and so forth. In some embodiments, the signal processing circuitry is part of the combine control circuitry, or a subsystem of such circuitry. Memory circuitry 84 is provided which may store parameters such as settings, scaling factors, data related to geometries of carts, and so forth, but also any programming used for determining heights of the surface areas of grain returning signals to the sensors, and for determining areas, volumes, and other parameters as discussed above.

It is contemplated that the system may allow for delivery of numerical, graphical, auditory, or some other indication to the combine operator related to the determined levels, areas, or volumes of grain being collected in the cart. One or more interfaces 86 will be provided for this purpose. As will be appreciated by those skilled in the art, where desired simple numerical indications may be displayed that indicate height of the grain, distance of the grain from the top of the cart sides, or any other parameter of interest. In addition, graphical displays may indicate the same type of information or even a more or less detailed depiction of filling of one or more sections of the cart. Such graphical representations might also display relative positions of the combine and cart, with progressing grain fill levels. Where desired auditory or other alarms may provide the operator with indications of recommended changes in fill location, for example.

It is also contemplated that the system may allow for open loop operation, where the combine operator, cart operator, or both are prompted to change the relative positions for grain delivery into the cart, but also, where desired, semi or fully automated (e.g., closed loop) operation. For example, cart (or combine) or spout (or nozzle) control circuitry 88 may interact with motion control systems of the combine or the cart, or both, such as via communication circuitry 90, which may be coupled by a network 92 to combine (and/or cart) control systems. In this way, fill levels and locations of filling may be automatically controlled, at least during parts of the harvesting and delivery into a particular cart.

It should be noted that some or all of the components may be provided in the combine, the cart, or both. Some may be provided in one of these, and data transferred to the other, such as by a wireless link. Thus, for example, the sensors may provide signals to circuitry in the cart, and certain raw or processed signals may be provided to the combine. Conversely, the sensors or some other component may provide signals to the combine where these are processed, and some form of processed signal (e.g., positioning recommendations or closed-loop positioning control signals) may be returned from the combine to the cart. All combinations of such components, component locations, and interactive and cooperative processing are contemplated as alternative embodiments of the present disclosure. Moreover, as mentioned above, relative positions of the combine and cart may be adjusted taking into account position determinations (and speeds) made based on GPS or any other suitable positioning system.

FIG. 7 is a diagram of an exemplary process 96 for sensing and analyzing data relating to filling of a grain cart. In this example, the sensors detect signals at operation 98, such as be emitting radar, ultrasound, or any other desired time-of-flight (or other) signals and detecting returned radiation. As noted above, however, the disclosure is not intended to be limited to these or any particular type of sensor or sensing technology. These signals are conditioned, processed, and ultimately distances between the sensors and the accumulating grain are determined, as indicated at operation 100. Any other parameter relating to the accumulating grain may then be computed (e.g., areas, volumes, locations, etc.), as indicated at operation 102. Based on these determinations, locations of delivery of grain may be changed to optimize filling of the cart, as indicated by operation 104. Again, these may entail changing of the relative positions of the combine, the cart, or both, or adjustment of some other aspect of the delivery system, such as the spout and/or nozzle positions. Moreover, the system may allow for control of starting and stopping of delivery of grain, as indicated by operation 106. This would be done, for example, when based on the detected grain levels, some problem has been detected that could otherwise result in loss of product or improper filling. Such starting and stopping of delivery will also be done during replacement of a full cart by an empty cart, as indicated by the cart loading analysis.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

1. A system comprising:
a sensor positioned to sense an upper surface of grain being transferred into a grain cart by a combine;
processing circuitry that receives and analyzes a signal based upon output of the sensor, and determines height data representative of height of the grain in the grain cart; and
an operator interface coupled to the processing system and that outputs an operator perceptible notice based on the height of the grain in the grain cart.

2. The system of claim 1, wherein the processing circuitry is configured to generate and output control signals for adjusting a position of the combine or the grain cart or both based on the height of the grain in the grain cart.

3. The system of claim 2, wherein the output signals cause relative advancement of either the combine or the grain cart with respect to one another.

4. The system of claim 1, wherein the processing circuitry is configured to generate and output control signals for adjusting a position of a spout or nozzle of the combine that extends at least partially over the grain cart during operation.

5. The system of claim 1, comprising a plurality of the sensors positioned to sense different points of the upper surface of the grain.

6. The system of claim 5, wherein a first sensor is positioned on a first lateral side of the grain cart, and a second sensor is positioned on a second lateral side of the grain cart.

7. The system of claim 5, wherein the processing circuitry is configured to determine an area or a volume of grain being transferred to the grain cart based on the output of the sensors.

8. The system of claim 1, wherein the sensor comprises an ultrasonic sensor.

9. The system of claim 1, wherein the sensor comprises a radar sensor.

10. A system comprising:
a plurality of sensors positioned to sense areas of an upper surface of grain being transferred into a grain cart by a combine;
processing circuitry that receives and analyzes signals based upon output of the sensors, and determines height, area, or volume data based on height of the grain in the grain cart; and
an operator interface coupled to the processing system and that outputs an operator perceptible notice based on the height of the grain in the grain cart.

11. The system of claim 10, wherein the processing circuitry is configured to generate and output control signals for adjusting a position of the combine or the grain cart or both based on the height of the grain in the grain cart.

12. The system of claim 11, wherein the output signals cause relative advancement of either the combine or the grain cart with respect to one another.

13. The system of claim 10, wherein the processing circuitry is configured to generate and output control signals for adjusting a position of a spout or nozzle of the combine that extends at least partially over the grain cart during operation.

14. The system of claim 10, wherein a first sensor is positioned on a first lateral side of the grain cart, and a second sensor is positioned on a second lateral side of the grain cart.

15. The system of claim 10, wherein the sensor comprises an ultrasonic sensor or a radar sensor.

16. A method comprising:
sensing, via a sensor, an upper surface of grain being transferred into a grain cart by a combine, and providing a resulting sensed signal to processing circuitry;
receiving and analyzing the sensed signal, in the processing circuitry, to determine at least one of height, area, or volume data representative of an amount of grain in the grain cart; and
providing on an operator interface an operator perceptible notice based on the amount of the grain in the grain cart.

17. The method of claim 16, wherein the processing circuitry is configured to generate and output control signals for adjusting a position of the combine or the grain cart or both based on the height of the grain in the grain cart.

18. The method of claim 16, wherein the processing circuitry is configured to generate and output control signals for adjusting a position of a spout or nozzle of the combine that extends at least partially over the grain cart during operation.

19. The system of claim 16, comprising a plurality of the sensors positioned to sense different points of the upper surface of the grain.

20. The system of claim 19, wherein a first sensor is positioned on a first lateral side of the grain cart, and a second sensor is positioned on a second lateral side of the grain cart.
